(19) United States
(12) Patent Application Publication
(10) Pub. No.: US 2026/0205542 A1
(43) Pub. Date: Jul. 16, 2026

(54) EMERGENCY CALLBACK SYSTEM FOR IN-VEHICLE INITIATED EMERGENCY CALLS WITH EMERGENCY PROBABILITY DETERMINATION

(71) Applicant: GM GLOBAL TECHNOLOGY OPERATIONS LLC, Detroit, MI (US)

(72) Inventors: Eric T. HOSEY, Rochester Hills, MI (US); Matthew Edward Gilbert-Eyres, Rochester Hills, MI (US); Russell A. Patenaude, Macomb Township, MI (US); Robert Myers, Canton, MI (US)

(21) Appl. No.: 19/016,065

(22) Filed: Jan. 10, 2025

(51) Int. Cl. H04M 3/51; H04M 3/493; H04W 4/90

(52) U.S. Cl. CPC H04M 3/5116; H04M 3/493; H04W 4/90

(57) ABSTRACT

A back-office safety calling device includes: a memory storing a factor table including factors associated with a host vehicle and a user, and a call event file that was generated when an emergency call was initiated; an interactive virtual machine assistant (IVMA) module calling back the user or the host vehicle where the emergency call was initiated and, while attempting to establish a connection to communicate with the user or during a current call with the user, determining whether the emergency call is associated with an actual emergency, associated with a non-emergency, or undetermined; and an unconfirmed emergency module, in response to the emergency call being undetermined, determining a probability of whether the emergency call is associated with an actual emergency based on the factors, and, based on the probability, routing the current call and/or the call event file to a non-emergency advisor device or an emergency advisor device.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to in-vehicle emergency communication systems.

A vehicle can include an emergency communication system that is configured to communicate with a back office regarding a provided service. In the event of an emergency, a user (e.g., driver) of the vehicle can press an emergency button and reach a trained advisor. The trained advisor can: collect details from the user and the vehicle regarding an emergency, state of the vehicle, state of occupants within the vehicle, environmental conditions, etc.; provide the user and/or vehicle occupants with guidance; and contact emergency services if needed to be directed to the location of the vehicle. The services provided by the trained advisor can include security services, emergency services, navigation services and diagnostic services.

### SUMMARY

A back-office safety calling device is disclosed and includes: a memory configured to store i) at least one factor table including factors associated with a host vehicle and a user of the host vehicle, and ii) a call event file, where the call event file was generated when an emergency call was initiated by the user via an emergency interface of the host vehicle or was initiated by the host vehicle; an interactive virtual machine assistant (IVMA) module configured to callback at least one of the user and the host vehicle where the emergency call was initiated and, while attempting to establish a connection to communicate with the user or during a current call with the user, determine whether the emergency call is i) associated with an actual emergency, ii) associated with a non-emergency, or iii) undetermined; and an unconfirmed emergency module configured i) in response to the emergency call being undetermined, to determine a probability of whether the emergency call is associated with an actual emergency based on the factors, and ii) based on the probability, route at least one of the current call and the call event file to a non-emergency advisor device or an emergency advisor device.

In other features, the unconfirmed emergency module is configured: in response to the probability being greater than a predetermined threshold, to route at least one of the current call and the call event file to the emergency advisor device; and in response to the probability being less than or equal to the predetermined threshold, to route at least one of the current call and the call event file to the non-emergency advisor device.

In other features, the unconfirmed emergency module is configured i) to weight the factors, and ii) to determine the probability based on the weighted factors.

In other features, the factors correspond to categories including a built-in or aftermarket paired devices category, a telematics connectivity data factor category, a vehicle usage data factor category, and a contextual button usage factor category.

In other features, the unconfirmed emergency module is configured i) to sum a number of plus signs associated with observed factors in each of the categories to obtain total values, ii) weight the total values with respective weights, iii) sum the weighted total values to provide a resultant total, iv) compare the resultant total to a predetermined threshold, and v) based on the comparison, route at least one of the current call and the call event file to the non-emergency advisor device or the emergency advisor device.

In other features, the IVMA module is configured, based on communication with the user and the factors, to determine whether to i) end the emergency call, ii) route the emergency call to the emergency advisor device, or iii) set a flag to have the probability determined.

In other features, the back-office safety calling device further includes a control module configured to collect sensor data from the host vehicle and set values of at least some of the factors based on the sensor data.

In other features, the interactive virtual machine assistant (IVMA) module implements an artificial intelligence neural network for speech recognition purposes when calling back the user and confirming whether the emergency call is associated with an actual emergency or is associated with a non-emergency.

In other features, the unconfirmed emergency module is configured to, when the IVMA module is unable to confirm an actual emergency or a non-emergency, implement a point-based algorithm to determine the probability based on a confidence threshold and context-based inputs.

In other features, the unconfirmed emergency module is configured to determine the probability based on outputs of at least one camera, at least one microphone, at least one biometric sensor, a radar sensor, at least one occupant sensor, at least one door sensor, and at least one mobile device.

In other features, the unconfirmed emergency module is configured to determine the probability based on diagnostic trouble codes, current driving data, previous call or voice recognition attempts, driving patterns, navigation routes, active safety events, and state of hazard lights.

In other features, the unconfirmed emergency module is configured to determine the probability based on network condition data, local emergency or crisis event data, weather, traffic information, geographical environment data, back-office availability, data regarding call results using other connectivity platforms, sourced 911 center data, and crowd-sourced or third party partner emergency data.

In other features, the unconfirmed emergency module is configured to determine the probability based on usage of emergency button, usage of end call button, lengths of button presses, and time between emergency button press and end call press.

In other features, an emergency callback system is disclosed and includes: the back-office safety calling device; the emergency advisor device; and the non-emergency advisor device.

In other features, an emergency callback method is disclosed and includes: storing i) at least one factor table including factors associated with a host vehicle and a user of the host vehicle, and ii) a call event file, where the call event file was generated when an emergency call was initiated by the user via an emergency interface of the host vehicle or was initiated by the host vehicle; calling back the user or the host vehicle where the emergency call was initiated via an interactive virtual machine assistant (IVMA) module and, while attempting to establish a connection to communicate with the user or during a current call with the user, determine whether the emergency call is i) associated with an actual emergency, ii) associated with a non-emergency, or iii) undetermined; and in response to the emergency call being undetermined, determining a probability of whether the emergency call is associated with an actual emergency based on the factors; and based on the probability, routing at least one of the current call and the call event file to a non-emergency advisor device or an emergency advisor device.

In other features, the emergency callback method further includes: in response to the probability being greater than a predetermined threshold, routing at least one of the current call and the call event file to the emergency advisor device; and in response to the probability being less than or equal to the predetermined threshold, routing at least one of the current call and the call event file to the non-emergency advisor device.

In other features, the emergency callback method further includes: weighting the factors; and determining the probability based on the weighted factors. The factors correspond to categories including a built-in or aftermarket paired devices category, a telematics connectivity data factor category, a vehicle usage data factor category, and a contextual button usage factor category.

In other features, the emergency callback method further includes: summing a number of plus signs associated with observed factors in each of the categories to obtain total values; weighting the total values with respective weights; summing the weighted total values to provide a resultant total; comparing the resultant total to a predetermined threshold; and based on the comparison, routing at least one of the current call and the call event file to the non-emergency advisor device or the emergency advisor device.

In other features, the emergency callback method further includes, when the IVMA module is unable to confirm an actual emergency or a non-emergency, implementing a point-based algorithm to determine the probability based on a confidence threshold and context-based inputs.

In other features, an in-vehicle emergency communication system is disclosed and includes: a telematics module configured to communicate with a back-office safety calling device; a perception module configured to collect vehicle status information and environmental condition information; an emergency interface including an emergency button; and an emergency module configured to receive an input signal from the emergency interface and initiate an emergency call via the telematics module, end the emergency call prior to confirmation of an emergency or non-emergency by the back-office safety calling device, receive a callback from an interactive virtual machine assistant of the back-office safety calling device to confirm an emergency or non-emergency.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example emergency callback system including a back-office safety calling device in accordance with the present disclosure;

FIG. 2 is a function block diagram of a vehicle including an example in-vehicle emergency communication system in accordance with the present disclosure;

FIG. 3 is a functional block diagram including an example emergency interface and emergency module of a vehicle in accordance with the present disclosure;

FIG. 4 illustrates an example emergency callback method implemented by a back-office safety calling device of FIG. 1;

FIG. 5 illustrates an example emergency call initiation method implemented by the in-vehicle emergency communication system of FIG. 2; and

FIG. 6 illustrates an example callback response method implemented by the in-vehicle emergency communication system of FIG. 2.

In the drawings, reference numbers may be reused to identify similar and/or identical elements.

### DETAILED DESCRIPTION

A user of a vehicle can press an emergency button of an in-vehicle emergency communication system to speak with an emergency advisor. The user may have accidentally pressed the emergency button or may change his or her mind with regards to speaking to an advisor, and as a result may quickly press an end call button. Because of the quick communication speeds of 4G and 5G communication systems, the call is typically received at a back-office and/or a public safety answering point (PSAP) prior to the user ending the call. It is typically not feasible for a user to end an accidentally triggered emergency call prior to the back-office being alerted of the call. The call is received quicker than the user realizes and as a result, the back-office and/or PSAP calls the user back to confirm whether this was an actual emergency call or not. Sometimes emergency calls can be unintentionally dropped (or ended). Thus, a response protocol can exist to callback each emergency call that has not been addressed by an emergency advisor. An emergency call that has ended and has not yet been addressed by an emergency advisor may be referred to as a “lost emergency call”. An emergency event corresponding to an emergency call that has ended and has not yet been addressed by an emergency advisor may be referred to as a “tracked emergency call event” and/or “pending emergency call event”.

Emergency button presses are often caused by accidental button presses and are often not associated with true emergencies. As many as half of emergency calls end after the back-office receives notice of the call and prior to the user being connected to a live agent and the call being addressed by an emergency advisor. However, each call needs to be initially treated as an emergency for due care of real emergencies. This can put a strain on when and where to focus essential and critically trained emergency advisors. Emergency advisors are trained professionals and their time is valuable. Thus, to minimize the amount of time that emergency advisors spend calling back users/vehicles of lost emergency calls, non-emergency advisors may first call back users/vehicles and then if there is an actual emergency transfer the call to an emergency advisor. However, sometimes when the non-emergency advisor calls back, the user does not respond. This could be because: the user is nervous and does not want to respond; the user has left the vehicle; or the user is unable to respond. As a result, the non-emergency advisor may need to: call back several times to the phone number of the original emergency call; call one or more other phone numbers on file for the user and/or owner of the vehicle; etc. There can be a considerable amount of time involved in resolving lost emergency calls.

Another option is to lock the in-vehicle emergency communication system buttons (e.g., end call button) after the emergency button is pressed to prevent a user from ending a call prior to the call being addressed by an emergency advisor. This significantly reduces the number of call backs. However, this causes emergency advisors to receive and address many calls that are not actually emergencies, which wastes a lot of emergency advisor time.

The examples set forth herein include a vehicle emergency callback system that determines a probability of whether a lost emergency call corresponds to an actual emergency. The vehicle emergency callback system calls back the user/vehicle (i.e., the original phone number from which the original emergency call was initiated) and/or another phone number on file associated with the original phone number. This is done via a virtual machine assistant (i.e., not a live assistant). The virtual machine assistant than determines whether to end the corresponding call and tracked emergency call event, transfer the call to an emergency advisor, or determine a probability of whether the lost emergency call corresponds with an actual emergency and transfer the call to a non-emergency advisor. As a result, the number of lost calls that are not associated with an actual emergency and end up being handled by an emergency advisor are significantly reduced and/or eliminated.

The examples include, in the event of a lost emergency call, an automated voice call system with artificial intelligence that calls users back. Artificial intelligence is used for voice recognition purposes. The vehicle emergency callback system is able to contextually confirm an emergency, confirm no emergency, or determine a probability of an emergency and react accordingly. Upon confirming an emergency, the call is transferred to a skilled emergency advisor. Upon confirming no emergency, the call is ended or transferred to a non-emergency advisor. Upon failure to connect via call back attempt(s) and/or upon failure to definitively determine the emergency status during the call back, the vehicle emergency callback system uses a weighted algorithm and defined probability factors highlighted in one or more emergency probability factor tables to evaluate whether the call is more likely an emergency or more likely not an emergency. If evaluated to be more likely an emergency, the active call is routed to a skilled emergency advisor. If the system was unable to connect the call, the activity to attempt to reach the user and handle the emergency case is recorded in a call event file, which is sent to the emergency advisor. If evaluated to be more likely not an emergency, the active call and/or call event file (referred to as a “case file”) is routed to a non-emergency advisor who is not skilled in emergency services. If the non-emergency advisor deems the event to be a true emergency, he/she can then transfer the call and/or case file to a skilled emergency advisor.

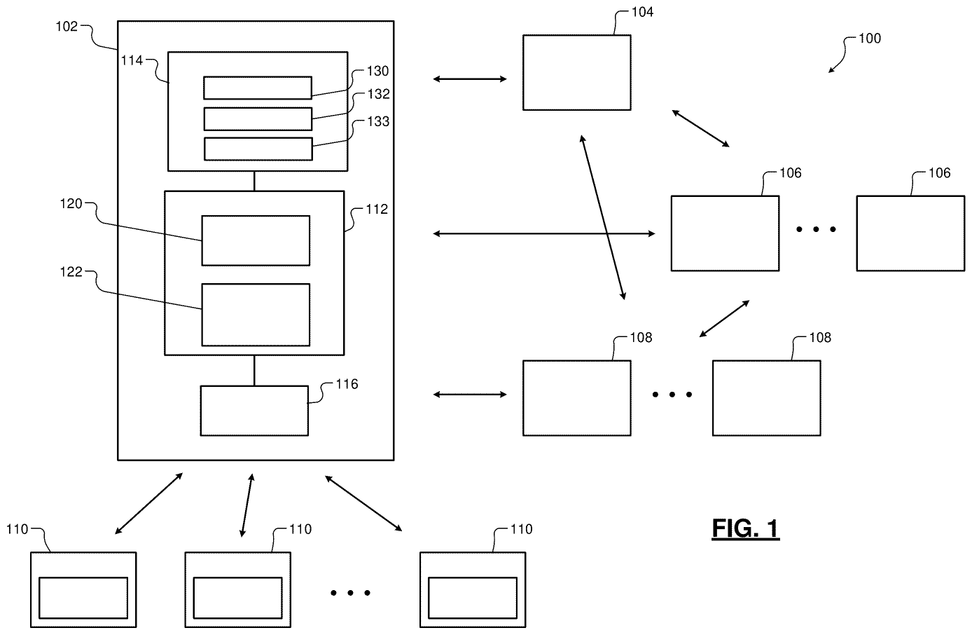

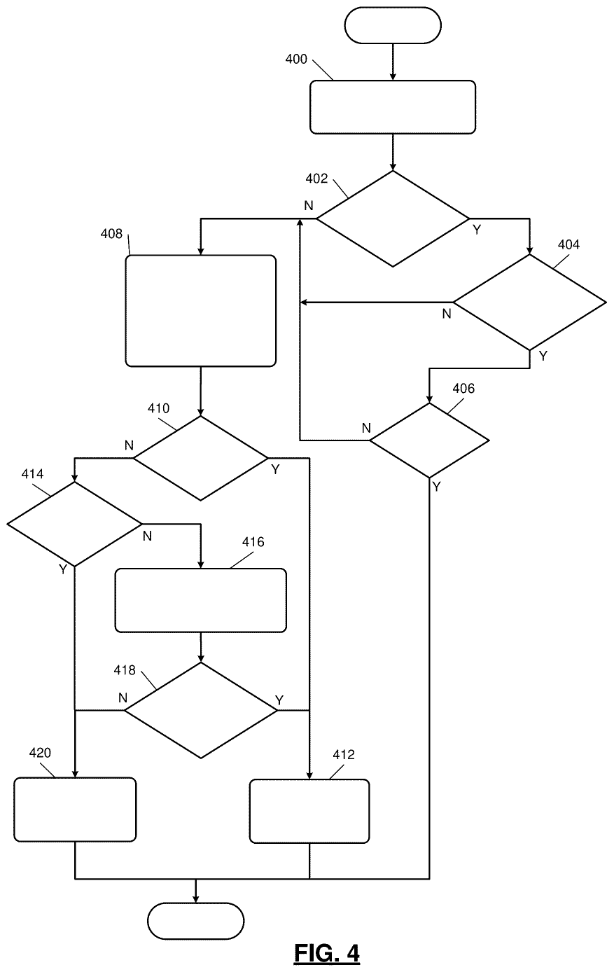

FIG. 1 shows an emergency callback system 100 that includes a back-office safety calling device 102, a public safety answering device (also referred to as a PSAP) 104, non-emergency advisor devices 106, emergency advisor devices 108, and vehicles 110. The back-office safety calling device 102 may be in communication with the devices 104, 106, 108 and the vehicles 110 and may include a control module 112, a memory 114, and a transceiver 116. The control module 112 may implement an emergency callback method, an example of which is shown in FIG. 4. The control module 112 may include an interactive virtual machine assistant (IVMA) module 120 and an unconfirmed emergency module 122.

The IVMA module 120 calls back phone numbers associated with lost calls and/or other phone numbers on file that are associated with the phone numbers of the lost calls. The IVMA module may include and/or implement an artificial intelligence (AI) neural network) for voice recognition purposes. When calling back, the IVMA module 120 asks an occupant of a vehicle that answers whether the original emergency call was for an actual emergency and/or or other questions. Based on the previous answers, the IVMA module 120 determines whether the call was for an actual emergency. Based on the received feedback from the occupant, the IVMA module 120: ends the call; determines the call to be associated with an emergency; determines the call to not be associated with an emergency; and/or determines the emergency status to be undetermined. When the IVMA module 120 is unable to reach a person and/or is unable to interpret what the vehicle occupant (or person answering the call) is saying, the IVMA module 120 may deem the emergency status of the call undetermined. When the status of the call is undetermined and/or not deemed an emergency, the unconfirmed emergency module 122 may determine a probability of whether the call is an emergency (or a probability of whether the call is not an emergency). When the probability exceeds a predetermined (or confidence) threshold, the call is deemed an emergency and routed to one of the emergency advisor devices 108. When the probability does not exceed the threshold, the call is deemed a non-emergency and is ended or routed to one of the non-emergency advisor devices 106.

The emergency advisor devices 108 may contact the public safety answering device 104 when an emergency exists to have police, fire, and/or medical emergency services requested. The public safety answering device 104 may be implemented with and/or integrated as part of the back-office safety calling device 102 or may be separate stand-alone device remotely located away from the back-off safety calling device 102. The public safety answering device 104 may be implemented at a call center or dispatch center that handles emergency calls and coordinated emergency responses.

The memory 114 may store tables 130, customer files 132, and call event files 133. Examples of the tables are provided below and referred to as Tables 1-10.

TABLE 1
Emergency Confirmation, Connection and Action Table

| Lost Emer- | | | | |
|---|---|---|---|---|
| gency Call | | | Emer- | |
| Tracked | End Call | First | gency | Second |
| Status | Button | Action | Probability | Action |
| Connected and | Confirmed | Route to | | |
| Confirmed | Emergency | Emergency | | |
| Emergency | | Advisor | | |
| Connected and | Confirmed | End Call | | |
| Confirmed No | No | | | |
| Emergency | Emergency | | | |
| Connected and | Could not | Determine | High | Route to |
| Could Not | Confirm | Probability | | Emergency |
| Confirm | Emergency | of | | Advisor |
| Emergency | | Emergency | Low | Route to |
| | | | | Non- |
| | | | | Emergency |
| | | | | Advisor |
| Could Not | Could not | Determine | High | Route to |
| Connect | Confirm | Probability | | Emergency |
| | emergency | of | | Advisor |
| | | Emergency | Low | Route to |
| | | | | Non- |
| | | | | Emergency |
| | | | | Advisor |

Table 1 provides the tracked status of an emergency call, whether an end call button has been pressed, a probability of whether the call is associated with an actual emergency, and actions taken. The actions may be taken by the control module 112.

TABLE 2
Emergency Probability Factor Table

| | Impact on |
|---|---|
| Factor in Determining Emergency Confidence | Confidence |
| Car Moving | − |
| Network Conditions | + |
| Panicked Voices | ++ |
| Calm Voices | − |
| Local Events - Other Emergency, Crisis | +++ |
| Area, etc. | |
| Other Calls - Guardian, etc. | ++ |
| DTCs | + |
| Recent Previous Calls or Repeated | + |
| Attempts | |
| Emergency Button Pressed More than A | +++ |
| First Predetermined Number of Times | |
| Indicating a Panic Situation | |
| Emergency Button Held Down for | + |
| Greater than First Predetermined Period | |
| of Time | |
| Emergency Button Held Down for Less | − |
| than a Second Predetermined Period of | |
| Time with Less than Predetermined | |
| Pressure (Indicating Accidental) | |
| End Call Button Pressed More Than a | −−− |
| Second Predetermined Number Of | |
| Times. | |
| End Call Button Held Down for Less than | + |
| the Second Predetermined Period of | |
| Time with Less Than Predetermined | |
| Pressure (Indicating Accidental) | |
| Less than Predetermined Period of Time | − |
| Between When Emergency Button | |
| Pressed and End Call Button Pressed | |
| Cameras/Microphones Data | Deterministic |
| Radar (Breathing, Biometrics, etc.) Data | Deterministic |
| Biometrics Data | Deterministic |
| Traffic Service Data Monitored for | ++ |
| Emergencies | |
| Rural vs Urban (Higher probability for | +++ (rural) |
| rural as there may be less people around | |
| to help and longer Public Safety | |
| Answering Point (PSAP) response time.) | |
| Back-Office Inavailability (DNA Issues, | + |
| Delays, Outages, etc.) | |
| Weather (Bad weather may have longer | + |
| PSAP Response time.) | |
| Occupancy - Passenger left the vehicle | Deterministic |
| or not (doors, seatbelts, seat sensors, | |
| cameras/microphone data checked) | |
| Recent Active Safety Events | + |
| Recent Erratic Driving Patterns | ++ |
| (swerving, speeding above normal | |
| pattern, smart driver alerts, in-vehicle | |
| coach alerts) | |
| Detect Bluetooth 911 Calls | +++ |
| Navigation to Hospital/Emergency | +++ |
| Location (or started moving towards | |
| hospital/emergency service location from | |
| their original heading) | |
| Recent in-vehicle speech | ++ |
| recommendation or use cases for | |
| emergency context. | |
| Hazard Lights Active | ++ |
| Sourced 911 Center Data Detected | +++ |
| Event | |
| Crown-sourced Emergency Incident | ++ |
| Platform Detected Event | |

Table 2 is an example of factors that may be considered when determining the probability of whether a call is associated with an actual emergency. In an embodiment, the more ‘+’ signs given a factor, the higher the weighting of that factor in determining the probability. The more ‘−’ signs given a factor, the lower the weighting of that factor in determining the probability. In an embodiment, each factor is weighted.

The following Tables 3-6 are an example for a lost emergency call having factors that are indicative of a high probability of an emergency. The factors may be grouped into, for example, four categories including a built-in or aftermarket paired devices (BAPD) category, a telematics connectivity data (TCD) category, a vehicle usage data (VUD) category, and a contextual button usage (CBU) category. In an embodiment, each category is weighted. In Tables 3-6, weights for each category are shown as examples. The Tables 3-6 include “Observed” columns indicating whether a factor has been observed or not. If there is an ‘X’ in the column, the factor has been observed. When a factor is “Deterministic”, the factor is able to be determined via in-vehicle sensors. The tables 3-6 further include total and weighted total values. The total value is equal to the number of ‘+’ signs for observed factors. The weighted total value is the product of the weight for that category and the total value. In an embodiment, the weighted totals are summed to provide a resultant total. If the resultant total is greater than a predetermined threshold (e.g., 10), then it is deemed that the call is associated with an actual emergency and is routed to one of the emergency advisor devices 108.

TABLE 3
BAPD Table

| Observed | BAPD - Weight = 0.6 | | Notes |
|---|---|---|---|
| | Calm Voices Detected | − | |
| X | Panicked Voices | ++ | |
| | Detected | | |
| X | Cameras/Microphones | Deterministic | Cameras detect |
| | | | frantic |
| | | | movements (++) |
| X | Radar (breathing, | Deterministic | Radar detects |
| | biometrics, etc.) | | distressed |
| | | | beathing (+++) |
| X | Biometrics | Deterministic | Biometrics detect |
| | | | heart issues (+++) |
| | Detect Bluetooth 911 | +++ | |
| | calls | | |

| | | |
|---|---|---|
| Total/Weighted Total | 10 | 6 |

TABLE 4
TCD Table

| Observed | TCD - Weight = 0.2 | | Notes |
|---|---|---|---|
| | Other Calls - | ++ | |
| | Guardian, etc. | | |
| | Local Events - | +++ | |
| | Other emergency, | | |
| | crisis area, etc. | | |
| x | Network Conditions | + | Network conditions |
| | | | are poor indicating |
| | | | possible call drop |
| | Monitor traffic | ++ | |
| | services for | | |
| | emergencies | | |
| x | Rural vs urban | +++ (rural) | Latitude/longitude |
| | (higher probability | | location indicates |
| | for rural as there | | rural area |
| | may be less people | | |
| | around to help and | | |
| | longer PSAP | | |
| | response time) | | |
| | Back Office | + | |
| | inavailability (DNA | | |
| | issues, delays, | | |
| | outages, etc.) | | |
| x | Weather (bad | + | |
| | weather may have | | |
| | longer PSAP | | |
| | response time, | | |
| | increase of | | |
| | accidents, etc. | | |
| | Sourced 911 center | +++ | |
| | data detected | | |
| | event | | |
| | Crowd-sourced | ++ | |
| | emergency incident | | |
| | platform detected | | |
| | event | | |

| | | |
|---|---|---|
| Total/Weighted Total | 5 | 1 |

TABLE 5
VUD Table

| Observed | VUD - Weight = 0.5 | | Notes |
|---|---|---|---|
| | Car Moving | − | |
| | DTCs | + | |
| | Recent Previous Calls | + | |
| | or Repeated Attempts | | |
| | Occupancy - Left the | Deterministic | |
| | vehicle or not (check | | |
| | door sensors, seatbelt | | |
| | sensors, seat sensors, | | |
| | cameras/microphones, | | |
| | etc.) | | |
| x | Recent Active Safety | + | |
| | Events | | |
| x | Recent Erratic Driving | ++ | |
| | Patterns (swerving, | | |
| | speeding above | | |
| | normal pattern, smart | | |
| | driver alerts, in-vehicle | | |
| | coach alerts) | | |
| | Navigation to | +++ | |
| | hospital/emergency | | |
| | location (or started | | |
| | moving towards | | |
| | hospital/emergency | | |
| | service location from | | |
| | their original heading) | | |
| | Look at recent in- | ++ | |
| | vehicle speech | | |
| | recommendation or | | |
| | use cases for | | |
| | emergency context | | |
| x | Hazard lights active | ++ | |

| | | |
|---|---|---|
| Total/Weighted Total | 5 | 2.5 |

TABLE 6
CBU Table

| Observed | CBU - Weight = 0.8 | | Notes |
|---|---|---|---|
| x | Emergency Button | +++ | |
| | Pressed Many | | |
| | Times Indicating | | |
| | Panic | | |
| | Emergency Button | + | |
| | Held Down for a | | |
| | Long Period | | |
| | Emergency Button | − | |
| | Held Down for | | |
| | Extremely Short | | |
| | Period with Less | | |
| | Pressure | | |
| | (Indicating | | |
| | Accidental | | |
| | Pressing of | | |
| | Emergency Button) | | |
| | End Call Button | −−− | |
| | Pressed More than | | |
| | a Predetermined | | |
| | Number of Times | | |
| | End Call Button | + | |
| | Held Down for Less | | |
| | than a | | |
| | Predetermined | | |
| | Period of Time with | | |
| | Less Than a | | |
| | Predetermined | | |
| | Amount of | | |
| | Pressure | | |
| | (Indicating | | |
| | Accidental | | |
| | Pressing of End | | |
| | Call Button) | | |
| | Less Than a | − | |
| | Predetermined | | |
| | Period of Time | | |
| | Between Presses | | |
| | of Emergency | | |
| | Button and End | | |
| | Call Button | | |

| | | |
|---|---|---|
| Total/Weighted Total | 3 | 2.4 |

As an example, expression 1 may be used to determine and compare a resultant total to a predetermined threshold (e.g., 10). If the resultant total is greater than the predetermined threshold, then there is a high probability that the call is associated with an emergency. If the resultant total is less than or equal to the predetermined threshold, then there is a low probability that the call is associated with an emergency. Expression 2 includes example values based on the above Tables 3-6 for BAPD, TCD, VUD and CBU.

$$0.6 * BAPD + 0.2 * TCD + 0.5 * VUD + 0.8 * CBU > 10 \qquad ( 1 )$$

$$0.6 * 10 + 0.2 * 5 + 0.5 * 5 + 0.8 * 3 = 11.9 ( > 10 ) \qquad ( 2 )$$

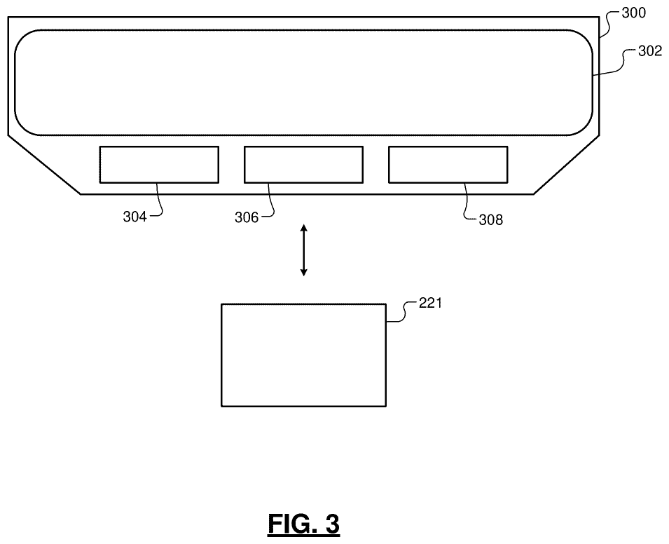

The emergency probability is HIGH in the above provided example of FIGS. 3-6.
Thus, the case is sent/routed to an emergency advisor device.

The following Tables 7-10 are an example for a lost emergency call having factors that are indicative of a low probability of an emergency.

TABLE 7
BAPD Table

| | Built-in or Aftermarket Paired | | |
|---|---|---|---|
| Observed | Devices (BAPD) - Weight = 0.6 | | Notes |
| | Calm Voices Detected | − | |
| X | Panicked Voices | ++ | |
| | Detected | | |
| | Cameras/Microphones | Deterministic | Cameras detect |
| | | | frantic |
| | | | movements (++) |
| | Radar (breathing, | Deterministic | Radar detects |
| | biometrics, etc.) | | distressed |
| | | | beathing (+++) |
| | Biometrics | Deterministic | Biometrics detect |
| | | | heart issues (+++) |
| | Detect Bluetooth 911 | +++ | |
| | calls | | |

| | | |
|---|---|---|
| Total/Weighted Total | −1 | −0.6 |

TABLE 8
TCD Table

| | Telematics Connectivity | | |
|---|---|---|---|
| Observed | Data (TCD) - Weight = 0.2 | | Notes |
| | Other Calls - | ++ | |
| | Guardian, etc. | | |
| | Local Events - | +++ | |
| | Other emergency, | | |
| | crisis area, etc. | | |
| | Network Conditions | + | Network conditions |
| | | | are poor indicating |
| | | | possible call drop |
| | Monitor traffic | ++ | |
| | services for | | |
| | emergencies | | |
| x | Rural vs urban | +++ (rural) | Latitude/longitude |
| | (higher probability | | location indicates |
| | for rural as there | | rural area |
| | may be less people | | |
| | around to help and | | |
| | longer PSAP | | |
| | response time) | | |
| | Back-Office | + | |
| | inavailability (DNA | | |
| | issues, delays, | | |
| | outages, etc.) | | |
| | Weather (bad | + | |
| | weather may have | | |
| | longer PSAP | | |
| | response time, | | |
| | increase of | | |
| | accidents, etc. | | |
| | Sourced 911 center | +++ | |
| | data detected | | |
| | event | | |
| | Crowd-sourced | ++ | |
| | emergency incident | | |
| | platform detected | | |
| | event | | |

| | | |
|---|---|---|
| Total/Weighted Total | 3 | 0.6 |

TABLE 9
VUD Table

| Observed | Vehicle Usage Data (VUD) - Weight = 0.5 | | Notes |
|---|---|---|---|
| x | Car Moving | − | |
| | DTCs | + | |
| | Recent Previous Calls | + | |
| | or Repeated Attempts | | |
| | Occupancy - Left the | Deterministic | |
| | vehicle or not (check | | |
| | door sensors, seatbelt | | |
| | sensors, seat sensors, | | |
| | cameras/microphones, | | |
| | etc.) | | |
| | Recent Active Safety | + | |
| | Events | | |
| | Recent Erratic Driving | ++ | |
| | Patterns (swerving, | | |
| | speeding above | | |
| | normal pattern, smart | | |
| | driver alerts, in-vehicle | | |
| | coach alerts) | | |
| | Navigation to | +++ | |
| | hospital/emergency | | |
| | location (or started | | |
| | moving towards | | |
| | hospital/emergency | | |
| | service location from | | |
| | their original heading) | | |
| | Look at recent in- | ++ | |
| | vehicle speech | | |
| | recommendation or | | |
| | use cases for | | |
| | emergency context | | |
| | Hazard lights active | ++ | |

| | | |
|---|---|---|
| Total/Weighted Total | −1 | −0.5 |

TABLE 10
CBU Table

| | Contextual Button | | |
|---|---|---|---|
| Observed | Usage (CBU) - Weight = 0.8 | | Notes |
| | Emergency Button | +++ | |
| | Pressed Many | | |
| | Times Indicating | | |
| | Panic | | |
| | Emergency Button | + | |
| | Held Down for a | | |
| | Long Period | | |
| x | Emergency Button | − | |
| | Held Down for | | |
| | Extremely Short | | |
| | Period with Less | | |
| | Pressure | | |
| | (Indicating | | |
| | Accidental | | |
| | Pressing of | | |
| | Emergency Button) | | |
| x | End Call Button | −−− | |
| | Pressed More than | | |
| | a Predetermined | | |
| | Number of Times | | |
| | End Call Button | + | |
| | Held Down for Less | | |
| | than a | | |
| | Predetermined | | |
| | Period of Time with | | |
| | Less Than a | | |
| | Predetermined | | |
| | Amount of | | |
| | Pressure | | |
| | (Indicating | | |
| | Accidental | | |
| | Pressing of End | | |
| | Call Button) | | |
| x | Less Than a | − | |
| | Predetermined | | |
| | Period of Time | | |
| | Between Presses | | |
| | of Emergency | | |
| | Button and End | | |
| | Call Button | | |

| | | |
|---|---|---|
| Total/Weighted Total | −5 | −4 |

Expression 3 includes the weights of the categories and example values based on the above Tables 7-10 for BAPD, TCD, VUD and CBU.

$$0.6 * - 1 + 0.2 * 3 + 0.5 * - 1 + 0.8 * - 5 = - 4.5 ( < 10 ) \qquad ( 3 )$$

The emergency probability is LOW in the provided example of FIGS. 7-10. Thus, the case is sent/routed to a non-emergency advisor.

The above referred to predetermined threshold is calibratable. The weights (or weight coefficients) are also calibratable. In an embodiment, weight coefficients are not used. This is effectively done by making each of the weights equal to 1. The above example of Tables 3-6 is an example of when a user is likely having a heart attack. This is based on in-vehicle devices that detect biometrics and indicate that the call was potentially dropped based on button usage and network conditions. The above example of Tables 7-10 is an example of when a user accidentally presses the emergency button in the vehicle and is determined based on contextual button usage.

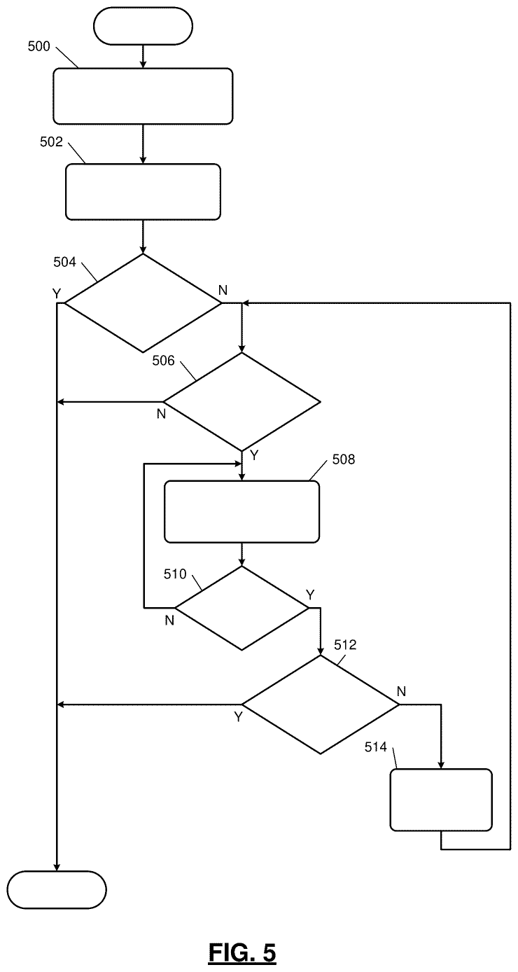

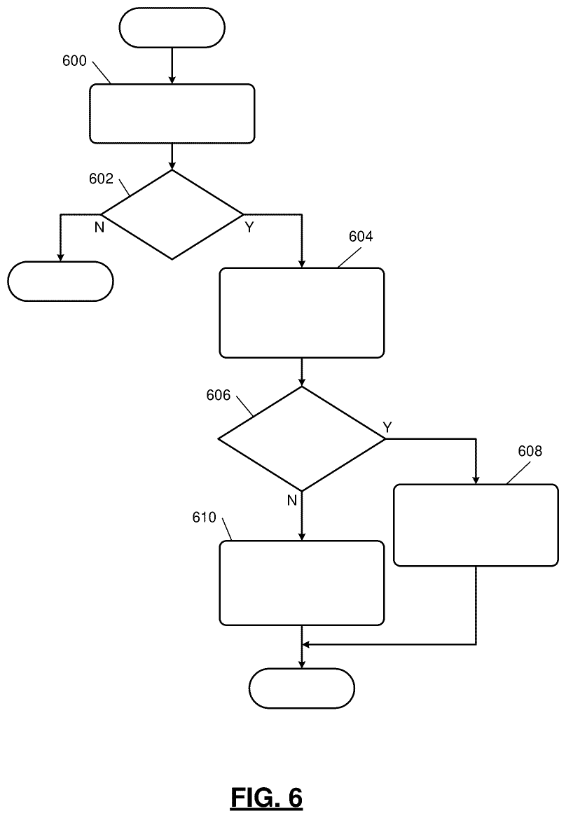

The vehicles 110 may include emergency modules 140, which communicate with the control module 112 when, for example, emergency buttons are pressed in the vehicles 110. An example emergency button is shown in FIG. 3. Example methods performed by each of the emergency modules 140 are shown in FIGS. 5-6.

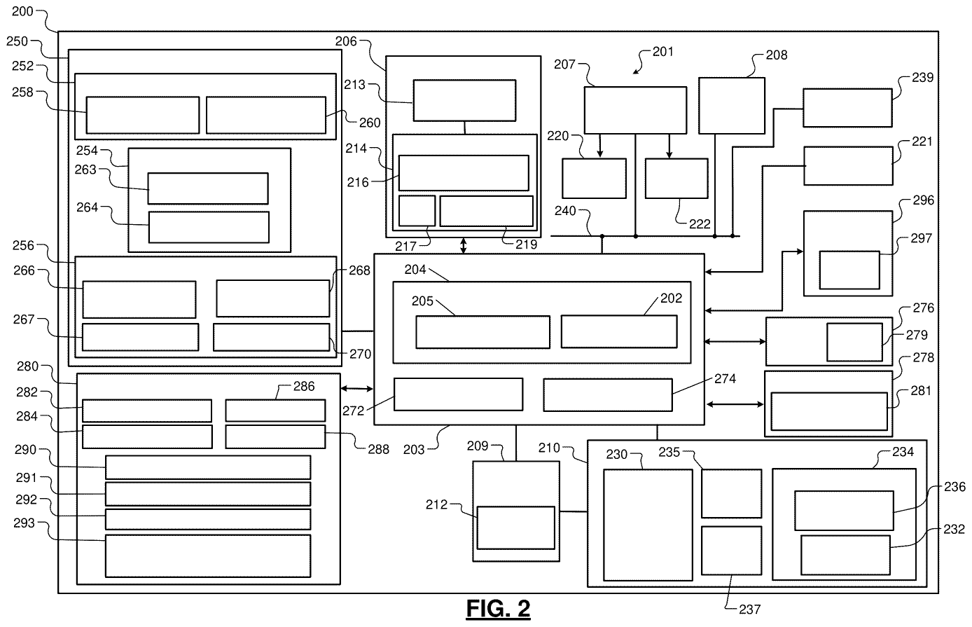

FIG. 2 shows a host vehicle 200 including an example in-vehicle emergency communication system 201 that is used for making emergency calls to a back-office as described herein. Each of the vehicles 110 of FIG. 1 may be configured similarly as the host vehicle 200. Some example operations of the in-vehicle emergency communication system 201 are described below with respect to the methods of FIGS. 5-6, which may be implemented by an emergency module 202 of a vehicle control module 203. The vehicle control module 203 includes a driving module 204 implementing a perception module 205 and the emergency module 202.

The driving module 204 and/or perception module 205 performs: perception (or situation) determining operations; object detection, identification, classification, and graphical and visual identification operations; data look-up, collection, and gathering operations; interaction timing operations; assisted driving operations; image overlay operations; dialog operations including providing speech, text, and/or haptic messages; etc. The perception module 205 may determine the state of the host vehicle 200, environmental conditions, weather, states and locations of other nearby vehicles and objects, etc. The vehicle control module 203 may perform various operations based on determinations made by the modules 202, 204, 205 and interactions with vehicle occupants such as a driver and/or passengers of the host vehicle 200.

The host vehicle 200 further includes one or more power sources 209, a telematics module 206, an infotainment module 207, other control modules 208 and a propulsion system 210. The vehicle control module 203 may control operation of the host vehicle 200 including the propulsion system 210 and other system described below. The power sources 209 may include one or more battery packs, a generator, a converter, a control circuit, terminals for high and low voltage loads, etc., as well as one or more battery sensors 212 for detecting states of the power sources 209 including voltages, current levels, states of charge, etc.

The telematics module 206 provides wireless communication services within the host vehicle 200 and wirelessly communicates with service providers, network devices (e.g., cloud-based network devices, central office devices, and/or back-office devices), other vehicles, mobile devices, infrastructure devices, and other devices external and/or internal to the host vehicle 200. The telematics module 206 may support Wi-Fi®, Bluetooth®, Bluetooth Low Energy (BLE), Ultra-Wideband (UWB), near-field communication (NFC), cellular, legacy (LG) transmission control protocol (TCP), long-term evolution (LTE), and/or other wireless communication and/or operate according to Wi-Fi®, Bluetooth®, BLE, UWB, NFC, cellular, and/or other wireless communication protocols. The telematics module 206 may include one or more transceivers 213 and a navigation module 214 with a global positioning system (GPS) and GNSS (or Global Navigation Satellite System) receiver 216. The navigation module 214 may include an inertial measurement unit (IMU) 217 and an odometer/wheel sensor 219. The transceivers 213 wirelessly communicate with network devices internal and external to the host vehicle 200 including cloud-based network devices, central stations, back offices, and portable network devices. The transceivers 213 may perform pattern recognition, channel addressing, channel access control, and filtering operations.

The navigation module 214 executes a navigation application to provide navigation services. The navigation services may include location identification services to identify where the host vehicle 200 is located. The navigation services may also include guiding a driver and/or directing the host vehicle 200 to a selected location. The navigation module 214 may communicate with a central station to collect map information indicating levels of traffic, transportation object identification and locations (e.g., locations and types of signs), path information, weather information, etc. As an example, if the host vehicle 200 is an assisted and/or automated driving vehicle, the navigation module 214 may direct the vehicle control module 211 along a selected route to a selected destination. The GPS and GNSS receiver 216 may provide: location information; velocity and/or direction (or heading) of the host vehicle 200, other vehicles, and objects (e.g., pedestrians and cyclists); and/or global clock timing information.

An emergency interface 221 is included and may include an emergency call button, an end call button, and one or more other buttons. An example of the emergency interface 221 is shown in FIG. 3. The emergency interface may be implemented as a rearview mirror, as a steering wheel, as a dashboard or center console interface, or as another type of interface. The emergency module 202 may make emergency calls based on input signals generated by the emergency interface 221.

The infotainment module 207 may include and/or be connected to an audio system 222 and/or a video system including one or more displays 220. The displays 220 and audio system 222 may be part of a human machine interface. The displays 220 may include cluster and/or center console displays, head-up displays, etc. Haptic devices (e.g., steering wheel and/or seat vibration devices) may be used in addition to the displays and the audio system 222 to interact with a vehicle occupant such as a driver or passenger. This interaction is further described below. Messages may be displayed, audibly played out, and/or indicated via the displays 220, the audio system 222, the haptic devices, and/or via one or more other output devices.

The infotainment module 207 may provide various information, warnings, and proactive messages including: status information; routing information, re-routing information, questions whether the host vehicle 200 should re-route from a current path to another path; whether driving operations are autonomously controlled, limited and/or prevented; gear shifter status; upcoming and currently being performed operations (e.g., braking, accelerating, turning operations); detected objects (or obstacles); vehicle status information; diagnostic information; prognostic information; entertainment features and information; etc. The infotainment module 207 may be used to guide a vehicle operator to a certain location, indicate trip estimations (e.g., distances to selected destinations), and other information.

The propulsion system 210 may include one or more torque sources, such as one or more motors and/or one or more engines (e.g., internal combustion engines). In the example shown in FIG. 2, the host vehicle 200 includes an engine 230 and one or more motors 232. The torque sources are independently controlled. The propulsion system 210 includes a motor control system 234 that includes the one or more motors 232 and a motor control module 236 that may control operation of the one or more motors 232 based on signals from the vehicle control module 211. The propulsion system 210 may include a gear selector and/or shifter 235 for setting a gear of a transmission 237 and/or for setting a drive state of one or more of the torque sources. The gear selector and/or shifter 235 may be an electronic selector (e.g., one or more electrical switches), a mechanical and/or electrical shifter, or other selector and/or shifter. The propulsion system 210 may be controlled based on position of an accelerator 239 (e.g., an accelerator pedal, a throttle plate, etc.).

The modules 202-208 may communicate with each other directly or indirectly via one or more buses 240, such as a controller area network (CAN) bus and/or other suitable interface. The vehicle control module 203 may control operation of vehicle modules, devices and systems based on feedback from sensors 250 and information and/or instructions received from a cloud-based network device.

The sensors 250 may include exterior sensors 252, interior sensors 254, and other sensors 256. The exterior sensors 252 may include radar and/or lidar sensors 258 and imaging and audio devices (e.g., visual spectrum cameras, long-wave infrared cameras, short-wave infrared cameras, ambient light sensors, and microphone or microphone array) 260. The exterior sensors 252 may be used to detect objects external to the host vehicle 200 and/or in a path of the host vehicle 200.

The interior sensors 254 may include one or more interior imaging sensors (e.g., cameras) 263, and a microphone or microphone array 264. The interior sensors 254 may be part of a driver monitoring system (DMS). The cameras 263 may be used to detect, track and/or monitor vehicle occupants including detecting locations of vehicle occupants in the vehicle, anatomical features (e.g., face, arms, hands, legs, etc.) of the vehicle occupants, head locations and/or eyes, etc. The interior sensors 254 may include door sensors, seat belt sensors, seat sensors, etc. The door sensor may indicate whether a door is open or closed. The seat belt sensors may indicate whether seat belts are buckled. The seat sensor may include, for example, load sensors, strain gauges, and/or piezoresistive or piezoelectric sensors for detecting whether an occupant is in a particular seat and the weight of the occupant.

The other sensors 256 may include a gear selector and/or shifter sensor 267, a vehicle speed sensor 266, acceleration sensors (e.g., longitudinal and lateral acceleration sensors) 268, and a fuel level sensor 270, as shown, and other sensors such as an inclinometer, an engine temperature sensor, and an engine oil pressure sensor. Additional sensors may also be included such as brake system sensors (a brake sensor 279 is shown) and steering system sensors (a steering angle sensor 281 is shown). The gear selector and/or shifter sensor 267 generates a signal indicative of a state of the gear selector and/or shifter 235.

The driving module 204 may use machine learning for facial recognition, determining locations of occupant limbs, for anatomical feature recognition, object classification including to identify and/or classify pedestrians, cyclists, and vehicles (e.g., oncoming traffic), as well as for probable trajectory determination of each detected, identified and/or classified object. The driving module 204 may determine the locations of objects based on feedback from the sensors 250.

The vehicle control module 203 may also include a mode selection module 272 and a parameter adjustment module 274. The parameter adjustment module 274 may be used to adjust parameters of the host vehicle 200. The vehicle control module 203 may perform autonomous operations based on interaction with a vehicle occupant. This may be based on instructions received from the control module 112 of the back-office safety calling device 102 of FIG. 1 and/or instructions from one of the devices 104, 106, 108 of FIG. 1. As an example, the vehicle control module 203 may operate in a fully or partially autonomous mode and may control the propulsion system 210, a brake system 276, and a steering system 278. In an embodiment, the vehicle control module 203 controls operation of the systems 210, 276 and 278 based on or without interactions with a vehicle occupant. The vehicle control module 203 may i) perform autonomous operations such as steering, braking, accelerating, etc., and/or ii) display and/or audibly playout messages, perform haptic operations via haptic devices, and/or output messages and/or corresponding signals via other output devices.

In an embodiment, the driving module 204 uses computer vision, machine learning and cloud computing to identify, communicate, and evaluate scenarios where a moving host vehicle should yield to pedestrian(s), an obstructed roadway, and/or oncoming (right-of-way) traffic. The driving module 204 visualizes and takes into consideration in real-time pedestrians, roadway obstructions and oncoming traffic and performs operations to provide enhanced situation awareness to vehicle occupants.

The driving module 204 is configured to perceive the road ahead and surrounding areas based on outputs of sensors (e.g., cameras, radar sensors, and/or lidar sensors) and vehicle-to-everything (V2X) communication including vehicle-to-vehicle communication, vehicle-to-mobile device communication, vehicle-to-infrastructure communication, and other communication (e.g., vehicle to distributed network communication).

The host vehicle 200 may further include the memory 280. The memory 280 may store sensor data 282, parameters 284, applications 286, algorithms 288, historical data 290, on-board inputs 291, off-board inputs 292 from other devices external to the host vehicle 200 and other data 293. The sensor data and parameters may include occupant locations, occupant weights, occupant heart rates, vehicle location, vehicle speed, vehicle acceleration, battery state of charge, fuel level, etc. applications 286. The applications 286 may include applications executed by the modules 202-208.

Although the memory 280 and the vehicle control module 203 are shown as separate devices, the memory 280 and the vehicle control module 203 may be implemented as a single device. The memory 280 may also store historical data 290 and other data 293 such as driver driving patterns, driver fueling patterns, driver stopping patterns, driver pickup patterns, other driver patterns, data collected by and/or generated by at least one of the modules 202-206, traffic data, navigation data, map data, GPS data, path data, speed data, and acceleration data, etc.

The vehicle control module 203 may control operation of the propulsion system 210, the video system including the display 220, the audio system 222, the haptic devices, the brake system 276, the steering system 278, a seating system 396, and/or other devices and systems according to parameters set by the modules 202-208, 274. The seating system 296 may include seat sensors 297 for detecting presence of an occupant and/or change in occupants, for example, change in a driver. The vehicle control module 203 may set at least some of the parameters based on signals received from the sensors 250.

The vehicle control module 203 may receive power from the power sources 209, which may be provided to the propulsion system 210, the brake system 276, the steering system 278, the seating system 296, etc. Power supplied to the haptic devices, the motors 232, the brake system 276, the steering system 278, the seating system 296, and/or actuators thereof may be controlled by the vehicle control module 203 to, for example, adjust: motor speed, torque, and/or acceleration; braking pressure; steering wheel angle; pedal position; state of haptic devices; etc. This control may be based on the outputs of the sensors 250, the navigation module 214, the GPS and GNSS receiver 216, the data and information received from external devices, and the data and information stored in the memory 280.

The vehicle control module 203 may determine various parameters including a vehicle speed, a motor speed, a gear state, an accelerator position, a brake pedal position, an amount of regenerative (charge) power, an amount of auto start/stop discharge power, and/or other information. The vehicle control module 203 may control operations of the systems 210, 276, 278 based on the stated parameters. The driving module 204 may display vehicle status information based on the stated parameters.

The host vehicle 200 can include various systems for assisting a driver, for performing autonomous operations, and/or for indicating to a vehicle occupant information regarding an environment of the host vehicle. For example, a host system may include a navigation system that provides map information indicating lane boundaries, street locations, speed limits, geographical locations of selected destinations, etc. The host system may provide the driver with instructions for driving to a selected destination and/or may perform autonomous operations such as braking, steering, and accelerating operations to drive the vehicle to the destination based on the map information.

As another example, the host vehicle 200 may include object detection and collision warning systems for detecting impending objects and performing countermeasures and/or taking evasive action to prevent a collision. The vehicle control module 203 determines locations of the objects relative to the host vehicle 200 and trajectories of the objects and the host vehicle 200. If it is determined that the host vehicle 200 is likely to collide with one of the objects, one or more warning signals may be generated to indicate to the driver and/or the object of concern of the potential collision. These warnings may be provided in addition to digital gateways and other information described herein. The vehicle control module 203 may also or alternatively perform one or more other countermeasures (e.g., apply brakes to decelerate the host vehicle, change a steering angle of the host vehicle, etc.) to prevent a collision.

FIG. 3 shows an emergency interface 300 and the emergency module 202 of FIG. 2. The emergency interface 300 is an example of the emergency interface 221 of FIG. 2. The emergency interface 300 is an example of a rear-view mirror assembly including a rear-view mirror 302, a call button 304, an end call button 306, and an emergency call button 308. The call button 304 may be pressed when a user is making a non-emergency call. The emergency call button 308 may be pressed by a user when there is an emergency. The end call button 306 may be pressed to end both non-emergency and emergency calls. The emergency module 202 performs operations based on an input signal generated by the emergency interface 300 due one of the buttons 304, 306, 308 being pressed.

FIG. 4 shows an emergency callback method implemented by a back-office safety calling device of FIG. 1. The following operations may be iteratively performed.

At 400, the control module 112 receives an emergency call from a host vehicle and creates a call event file to track information such as whether the emergency call has been confirmed to be associated with an emergency, whether the call was dropped, whether the emergency call has been addressed if need be by an emergency advisor, etc.

At 402, the control module 112 determines whether a voice connection has been established with a user in the host vehicle. If yes, operation 404 is performed, otherwise operation 408 is performed.

At 404, the control module 112 determines whether an end call button has been pressed. If yes operation 406 is performed, otherwise operation 408 may be performed.

At 406, the control module 112 determines whether the call was completed. If yes, the method may end, otherwise operation 408 may be performed.

At 408, the IVMA module 120 activates interactive voice assistant (i.e., performs IVMA operations) to call host vehicle and/or phone number on record and associated with the phone number used to make the emergency call. The IVMA operations include communicating with the user and/or occupants in the vehicle to collect information and confirm whether the call is a non-emergency call or an emergency call. The phone number on record may be another phone number of the user that initiated the emergency call, a phone number of an owner or renter of the host vehicle, a phone number of a registered user of the vehicle, a phone number of an occupant of the vehicle, etc.

At 410, The IVMA module 120 determines whether an emergency has been confirmed. If yes, operation 412 may be performed, otherwise operation 414 may be performed.

At 412, the IVMA module 120 may transfer the call and/or the call event file and corresponding collected information to an emergency advisor device of an emergency advisor. This may include transmitting a signal to the emergency advisor device to allow the emergency advisor to address the call. The method may end subsequent to operation 412.

At 414, the IVMA module 120 and/or the unconfirmed emergency module 122 determines whether a non-emergency has been confirmed. If no, operation 416 may be performed, otherwise operation 420 may be performed. The IVMA module 120 may set a flag to have a probability of an emergency (or non-emergency) determined.

At 416, the unconfirmed emergency module 122 may determine, based on the original call, results of the current call, collected sensor data, and other collected information, a probability of an unconfirmed emergency (or a probability of a confirmed emergency) as described above. The probability is determined based on various factors and weights, as described above with respect to Tables 1-10.

At 418, the unconfirmed emergency module 122 determines whether the probability is greater than a predetermined threshold. If yes, operation 412 may be performed, otherwise operation 420 may be performed.

At 420, the unconfirmed emergency module 122 transfers the call, the call event file, and related information to a non-emergency advisor device of a non-emergency advisor. The non-emergency advisor may then reconfirm that this is not an emergency and address the user's concerns. If the non-emergency advisor determines that the call is actually an emergency call, the non-emergency advisor via the non-emergency advisor device can forward the call, the call event file, and related information to the emergency advisor device.

After completing operations 406, 412, and 420, the call event file may be closed, stored for future reference, or discarded.

FIG. 5 shows an emergency call initiation method implemented by the in-vehicle emergency communication system 201 of FIG. 2. The following operations may be iteratively performed.

At 500, the emergency button of the emergency interface 221 is pressed and an input signal is generated, as described above or the emergency module 202 initiates a call request. An emergency call may be initiated by a user via the emergency interface 221 of the host vehicle 200 or may be initiated by the host vehicle 200 (referred to as an automatic emergency call). The host vehicle 200 initiated emergency call may be initiated by, for example, the emergency module 202 due to detected states of the host vehicle, detection of a collision that involved the host vehicle, environmental conditions, detected states of occupants of the host vehicle, etc.

At 502, the emergency module 202 initiates a call with the back-office via the telematics module 206 and begins to establish a voice connection with the back-office.

At 504, the emergency module 202 determines whether the end call button of the emergency interface has been pressed. If yes, the call ends and the method ends. If not, operation 506 may be performed.

At 506, the emergency module 202 determines whether a voice connection has been established. If no, the method may end, otherwise operation 508 may be performed.

At 508, the emergency module 202 proceeds with the call with emergency advisor. The emergency module 202 communicates with the emergency advisor device via the telematics module 206.

At 510, the emergency module 202 determines whether the voice connection is lost and/or ended. If yes, operation 512 may be performed, otherwise operation 508 may continue.

At 512, the emergency module 202 determines whether the end call button has been pressed. If yes, the method may end, otherwise operation 514 may be performed.

At 514, the emergency module 202 may attempt to reestablish a voice connection with the emergency advisor. Operation 506 may be performed subsequent to operation 514.

FIG. 6 shows a callback response method implemented by the in-vehicle emergency communication system 201 of FIG. 2. The following operations may be iteratively performed. Although the following method is primarily described with respect to when there is a callback to the telematics module 206 of the host vehicle 200, the method may be modified for when the callback is to another device (e.g., a user's mobile device such as a cell phone, a tablet, a wearable device, etc.).

At 600, the emergency module 202 via the telematics module 206 receives a call (referred to as the current call) from the IVMA module 120 of the back-office safety calling device 102 of FIG. 1.

At 602, the emergency module 202 determines whether the current call is answered by a vehicle occupant. The current call may be answered via the emergency interface 221. As an example, the current call may be answered by pressing one of the buttons 304, 308 of FIG. 3 or another button (not shown) of the emergency interface 221 or other device. If the current call is answered, operation 604 may be performed, otherwise the method may end.

At 604, the emergency module 202 proceeds with the current call to i) confirm that the original emergency call is associated with a non-emergency, or ii) determine that the original emergency call is actually associated with an emergency.

At 606, the emergency module 202 determines whether the original emergency call is associated with an emergency. If yes, operation 608 may be performed, otherwise operation 610 may be performed.

At 608, the emergency module 202 proceeds with the current call allowing the vehicle occupant to communicate with an emergency advisor. At 610, the emergency module 202 proceeds with current call allowing the vehicle occupant to communicate with a non-emergency advisor. The method may end subsequent to operations 608, 610.

The examples set forth herein efficiently handle ended or dropped emergency calls without wasting skilled emergency advisor resources while still ensuring all true emergencies are appropriately cared for by emergency advisors.

The examples include a system that utilizes an automated voice recognition system and artificial intelligence to call customers back if a potential emergency call is dropped or ended.

The examples include a system that is capable of automatically detecting whether the lost call was no emergency, low probability of an emergency, high probability of an emergency, or a confirmed emergency.

The examples include a system that reacts accordingly after an emergency determination by ending the call, routing the call and/or the case to a non-emergency advisor, or routing the call and/or the case directly to a skilled emergency advisor.

The examples include a system that uses voice recognition via direct customer interaction to confirm a true emergency or no emergency.

The examples include a system that uses a point-based algorithm to determine a high/low probability of an emergency using a predetermined (or confidence) threshold-based algorithm with multiple context-based inputs when the system cannot confirm emergency or no emergency via direct user (or vehicle occupant) voice interaction.

The examples include a system that uses several built-in or aftermarket paired devices to help determine emergency probability such as cameras, microphones, biometrics, radar, occupant sensors, door sensors, Bluetooth® phones/devices, etc.

The examples include a system that uses vehicle usage data to help determine an emergency probability. The vehicle usage data includes diagnostic trouble codes, current driving data, previous call or voice recognition attempts, driving patterns, navigation routes, active safety events, state of hazard lights, etc.

The examples include a system that uses telematics connectivity data to help determine an emergency probability. The telematics connectivity data includes network condition data, local emergency or crisis event data, weather, traffic information, geographical environmental data, back-office availability, data regarding call results using other connectivity platforms, sourced 911 center data, crowd-sourced or third-party partner emergency data, etc.

The examples include a system that uses contextual button usage to help determine emergency probability such as panicked emergency button mashing, usage of the end call button, length of button presses, time between emergency and end call presses, etc.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A back-office safety calling device comprising:
a memory configured to store i) at least one factor table including a plurality of factors associated with a host vehicle and a user of the host vehicle, and ii) a call event file, wherein the call event file was generated when an emergency call was initiated by the user via an emergency interface of the host vehicle or was initiated by the host vehicle;
an interactive virtual machine assistant (IVMA) module configured to callback at least one of the user and the host vehicle where the emergency call was initiated and, while attempting to establish a connection to communicate with the user or during a current call with the user, determine whether the emergency call is i) associated with an actual emergency, ii) associated with a non-emergency, or iii) undetermined; and
an unconfirmed emergency module configured i) in response to the emergency call being undetermined, to determine a probability of whether the emergency call is associated with an actual emergency based on the plurality of factors, and ii) based on the probability, route at least one of the current call and the call event file to a non-emergency advisor device or an emergency advisor device.

2. The back-office safety calling device of claim 1, wherein the unconfirmed emergency module is configured:
in response to the probability being greater than a predetermined threshold, to route at least one of the current call and the call event file to the emergency advisor device; and
in response to the probability being less than or equal to the predetermined threshold, to route at least one of the current call and the call event file to the non-emergency advisor device.

3. The back-office safety calling device of claim 1, wherein the unconfirmed emergency module is configured i) to weight the plurality of factors, and ii) to determine the probability based on the weighted plurality of factors.

4. The back-office safety calling device of claim 1, wherein the plurality of factors correspond to a plurality of categories including a built-in or aftermarket paired devices category, a telematics connectivity data factor category, a vehicle usage data factor category, and a contextual button usage factor category.

5. The back-office safety calling device of claim 4, wherein the unconfirmed emergency module is configured i) to sum a number of plus signs associated with observed factors in each of the plurality of categories to obtain a plurality of total values, ii) weight the plurality of total values with respective weights, iii) sum the weighted plurality of total values to provide a resultant total, iv) compare the resultant total to a predetermined threshold, and v) based on the comparison, route at least one of the current call and the call event file to the non-emergency advisor device or the emergency advisor device.

6. The back-office safety calling device of claim 1, wherein the IVMA module is configured, based on communication with the user and the plurality of factors, to determine whether to i) end the emergency call, ii) route the emergency call to the emergency advisor device, or iii) set a flag to have the probability determined.

7. The back-office safety calling device of claim 1, further comprising a control module configured to collect sensor data from the host vehicle and set values of at least some of the plurality of factors based on the sensor data.

8. The back-office safety calling device of claim 1, wherein the interactive virtual machine assistant (IVMA) module implements an artificial intelligence neural network for speech recognition purposes when calling back the user and confirming whether the emergency call is associated with an actual emergency or is associated with a non-emergency.

9. The back-office safety calling device of claim 1, wherein the unconfirmed emergency module is configured to, when the IVMA module is unable to confirm an actual emergency or a non-emergency, implement a point-based algorithm to determine the probability based on a confidence threshold and a plurality of context-based inputs.

10. The back-office safety calling device of claim 1, wherein the unconfirmed emergency module is configured to determine the probability based on outputs of at least one camera, at least one microphone, at least one biometric sensor, a radar sensor, at least one occupant sensor, at least one door sensor, and at least one mobile device.

11. The back-office safety calling device of claim 1, wherein the unconfirmed emergency module is configured to determine the probability based on diagnostic trouble codes, current driving data, previous call or voice recognition attempts, driving patterns, navigation routes, active safety events, and state of hazard lights.

12. The back-office safety calling device of claim 1, wherein the unconfirmed emergency module is configured to determine the probability based on network condition data, local emergency or crisis event data, weather, traffic information, geographical environment data, back-office availability, data regarding call results using other connectivity platforms, sourced 911 center data, and crowd-sourced or third party partner emergency data.

13. The back-office safety calling device of claim 1, wherein the unconfirmed emergency module is configured to determine the probability based on usage of emergency button, usage of end call button, lengths of button presses, and time between emergency button press and end call press.

14. An emergency callback system comprising:
the back-office safety calling device of claim 1;
the emergency advisor device; and
the non-emergency advisor device.

15. An emergency callback method comprising:
storing i) at least one factor table including a plurality of factors associated with a host vehicle and a user of the host vehicle, and ii) a call event file, wherein the call event file was generated when an emergency call was initiated by the user via an emergency interface of the host vehicle or was initiated by the host vehicle;
calling back the user or the host vehicle where the emergency call was initiated via an interactive virtual machine assistant (IVMA) module and, while attempting to establish a connection to communicate with the user or during a current call with the user, determine whether the emergency call is i) associated with an actual emergency, ii) associated with a non-emergency, or iii) undetermined; and
in response to the emergency call being undetermined, determining a probability of whether the emergency call is associated with an actual emergency based on the plurality of factors; and
based on the probability, routing at least one of the current call and the call event file to a non-emergency advisor device or an emergency advisor device.

16. The emergency callback method of claim 15, further comprising:
in response to the probability being greater than a predetermined threshold, routing at least one of the current call and the call event file to the emergency advisor device; and
in response to the probability being less than or equal to the predetermined threshold, routing at least one of the current call and the call event file to the non-emergency advisor device.

17. The emergency callback method of claim 15, further comprising:
weighting the plurality of factors; and
determining the probability based on the weighted plurality of factors,
wherein the plurality of factors correspond to a plurality of categories including a built-in or aftermarket paired devices category, a telematics connectivity data factor category, a vehicle usage data factor category, and a contextual button usage factor category.

18. The emergency callback method of claim 17, further comprising:
summing a number of plus signs associated with observed factors in each of the plurality of categories to obtain a plurality of total values;
weighting the plurality of total values with respective weights;
summing the weighted plurality of total values to provide a resultant total;
comparing the resultant total to a predetermined threshold; and
based on the comparison, routing at least one of the current call and the call event file to the non-emergency advisor device or the emergency advisor device.

19. The emergency callback method of claim 15, further comprising, when the IVMA module is unable to confirm an actual emergency or a non-emergency, implementing a point-based algorithm to determine the probability based on a confidence threshold and a plurality of context-based inputs.

20. An in-vehicle emergency communication system comprising:
a telematics module configured to communicate with a back-office safety calling device;
a perception module configured to collect vehicle status information and environmental condition information;
an emergency interface comprising an emergency button; and
an emergency module configured to receive an input signal from the emergency interface and initiate an emergency call via the telematics module, end the emergency call prior to confirmation of an emergency or non-emergency by the back-office safety calling device, receive a callback from an interactive virtual machine assistant of the back-office safety calling device to confirm an emergency or non-emergency.
